(19) United States
(12) Patent Application Publication
(10) Pub. No.: US 2008/0028802 A1
(43) Pub. Date: Feb. 7, 2008

(54) Receiving apparatus

(76) Inventors: Glenn Thomas Jordan, Indian Springs, OH (US); Jeremy Todd Kempin, West Chester, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/888,438

(22) Filed: Aug. 1, 2007

Related U.S. Application Data
(60) Provisional application No. 60/834,729, filed on Aug. 1, 2006.

(51) Int. Cl. D06F 39/02; B65D 83/14; B65D 83/76; B65D 85/00; B67D 5/06; B67D 5/42; B67D 5/44

(52) U.S. Cl. 68/12.18; 222/1; 222/251; 222/372; 222/383.1; 222/394; 222/395; 222/399; 222/409

(57) ABSTRACT

The present invention relates to a receiver for a laundry product having a tap, laundry appliances comprising one or more receivers for one or more laundry products each having a tap and methods thereof.

### CROSS REFERENCE TO RELATED APPLICATION

This application claims the benefit of U.S. Provisional Application Ser. No. 60/834,729, filed Aug. 1, 2006.

### FIELD OF THE INVENTION

The present invention relates to a receiver for a laundry product having a tap, laundry appliances comprising one or more receivers for one or more laundry products each having a tap and methods thereof.

### BACKGROUND OF THE INVENTION

Conventional laundry appliances are typically supplied with a laundry composition, such as laundry detergent, fabric softener and the like, either through direct application, i.e. the consumer manually supplies the laundry composition into the wash tub, or via indirect application, i.e. the consumer fills a single dose dispenser, (which may be built into the laundry appliance or free standing), such as the DOWNY Ball. In either direct or indirect application, the consumer must physically supply the composition, at each washing event, which is generally time consuming, awkward, and messy.

A number of solutions have been proposed to reduce, if not eliminate, these problems associated with consumer dosed laundry compositions, either directly or indirectly. One present attempt at solving such problems is to provide the laundry appliance with built-in dispensers that can hold a larger amount of laundry composition to facilitate multiple dispensing events during multiple laundering cycles. However, this is ultimately unsatisfactory as refilling of these built-in dispensers is typically also time consuming, awkward, and messy. Another problem associated with built-in dispensers is that the consumer may unknowingly/unwittingly mix incompatible composition in the dispensers. These incompatible compositions, such as a heavy duty liquid detergent (or HDL) containing bleach and a different HDL containing bleach incompatible ingredients, (for example, enzymes, perfume, dye, surfactants, etc), could interact within the laundry appliance and, potentially damage the machine, fabrics sought to be laundered or, at best generally lessen the cleaning power associated with the detergents individually. Additionally, these larger dispensers often cannot be easily retrofitted to existing laundry appliances.

One proposed solution to these cumulative issues is to provide the laundry appliance with direct access to the laundry composition in the package sold to the consumer. For instance, one attempted solution has been through a so called dip tube, which is placed in to the composition in the package. Such a dip tube is helpful, but still may be problematic as the tube will likely dribble composition out when a replacement package is being added, thereby causing mess.

Another proposed solution is to use either a custom designed package that is specifically adapted to fit the laundry composition input of a laundry appliance, or have a portion of the package that can be pierced by an integral laundry appliance dispensing spike. While these proposed solutions would, in theory, potentially reduce the spillage of composition, they would require the creation of a specific package which would likely be usable with only laundry appliances made by one manufacturer. The additional cost of creating a new package which would be only usable on a few laundry appliances and may have a very short commercial life, is not appealing to consumers, laundry products manufacturers or appliance manufacturers, and has limited use.

Consequently, the need remains for a system, device and/or method to provide multiple doses of a composition, such as laundry compositions, to a laundry appliance, which reduces or eliminates mess and works efficiently with conventional laundry packaging.

### SUMMARY OF THE INVENTION

One aspect of the invention relates to a receiver for a laundry product, wherein the laundry product has a tap, said receiver comprising:
(a) a connector adapted for releasably attaching the receiver to the tap, wherein the connector, when attached to the tap, is in fluid communication with the tap; and
(b) a dispensing means in association with the connector.

Another aspect of the invention relates to a laundry appliance comprising:
(1) at least one receiver for a laundry product, wherein the laundry product has a tap, said receiver comprising:
   (a) a connector adapted for releasably attaching the receiver to the tap, wherein the connector, when attached to the tap, is in fluid communication with the tap; and
   (b) a dispensing means in association with the connector.

### BRIEF DESCRIPTION OF THE DRAWINGS

In the accompanying drawings:

FIG. 1 is an illustrative example of a perspective view of one laundry product having a tap.

FIG. 2 is an illustrative example of a perspective view of another laundry product having a tap.

FIG. 3 is an illustrative example of a side view of one laundry product having a tap.

FIG. 4 is an illustrative example of a perspective view of one possible receiver.

FIG. 5 is a perspective view of the receiver of FIG. 4 showing the tap of a laundry product removably attached to the connector.

FIG. 6 is another perspective view showing the receiver of FIG. 4 and the tap of a laundry product attached to the connector with the tap in the open position actuated by a gear.

FIG. 7 is a schematic illustrative example of a receiver and a laundry product.

FIG. 8 is a sectional view of the receiver and tap illustrated in FIG. 5 in the closed position.

FIG. 9 is a sectional view of the receiver and tap illustrated in FIG. 5 in the open position.

FIG. 10 is another schematic illustrative example of a receiver and a laundry product.

FIG. 11 is an illustrative example of a front view of a laundry appliance having a receiver with removably attached thereto a laundry product having a tap.

FIG. 12 is another illustrative example of a front view of a laundry appliance having a receiver with removably attached thereto a laundry product having a tap.

FIG. 13 is an illustrative example of a front view of a pair of laundry appliances, a washer and a dryer, each having a receiver with removably attached thereto a different laundry product having a tap.

FIG. 14 is an illustrative example of a front view of a laundry appliance mounted on a drawer.

FIG. 15 is an illustrative example of a top view of one possible drawer configuration of a laundry appliance illustrated in FIG. 14.

### DETAILED DESCRIPTION OF THE INVENTION

### Definitions

As used herein “laundry appliance” means any apparatus, machine or device which is designed to perform an operation on fabrics that are placed therein. Illustrative examples of laundry appliances include, washing machines, including top loading washing machines, front loading washing machine, twin tub washing machines and the like; dryers such as, tumble dryers and the like; and 2-in-1 appliances, i.e., an appliance that's a combination washer and dryer.

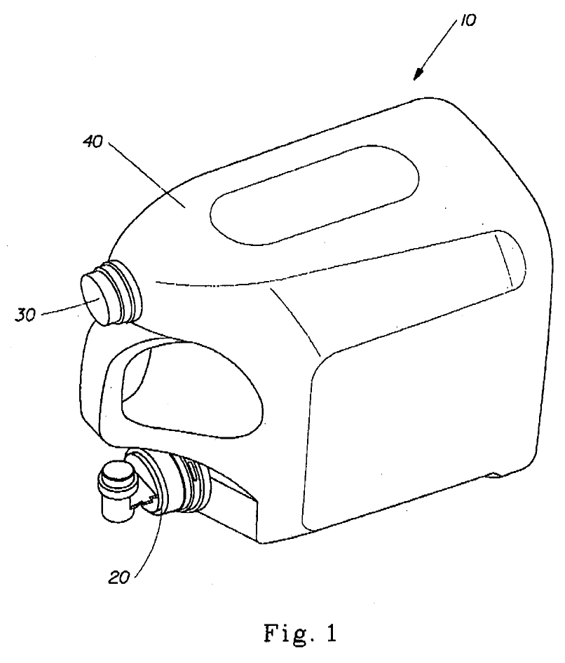

As used herein, “laundry product” refers to in the broadest to include any package, container or the like that has a tap, and contains therein a flowable composition which is typically used in the laundry or imparts a laundry benefit, such as, fabric cleaning, whiteness maintenance, softening, freshness, scent, bleaching, static control, absorbency, color care, or wrinkle control, and the like, to fabrics during the laundering process. The laundry product may be of any suitable size or shape so long as it has a tap. The laundry product may be a multi compartment container. FIGS. 1 to 3 provide illustrative examples of laundry product of different size and shapes. The laundry product may, if needed vent in any suitable fashion, such as, via a self venting tap, venting cap, or the like.

FIG. 1 illustrates one possible laundry product 10, having a tap 20, a venting cap 30 and a body 40. The laundry product 10 is illustrative of laundry products that are readily available to consumers when they purchase in bulk from a grocery store, supermarket, or from a club or warehouse store, such as SAMS CLUB or COSTCO. These laundry products 10 are designed to carry significant volumes of flowable compositions and enable a consumer to save money and time by buying in bulk.

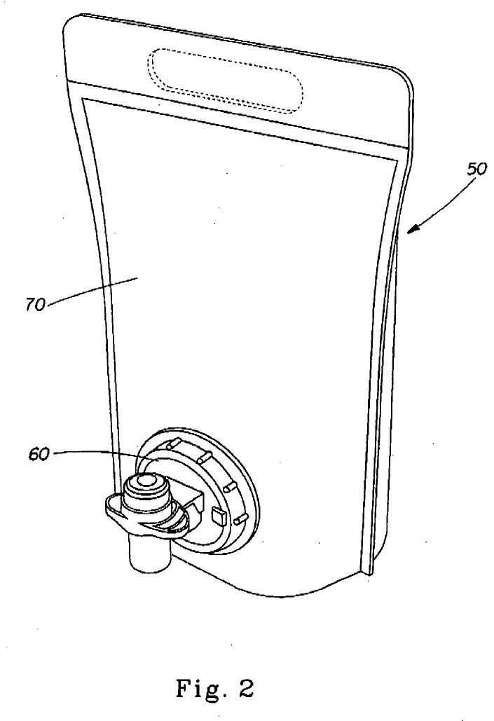

FIG. 2 illustrates another possible laundry product 50, having a tap 60 and a body 70. Unlike the laundry product 10 of FIG. 1, laundry package 50 does not require a vent or venting cap as the body 70 collapses, as the flowable composition is dispensed therefrom. In one possible embodiment, the laundry package 50 could be placed in a secondary package, such as a cardboard box or shell or even in a polymeric container, thereby forming a bag in bottle type package.

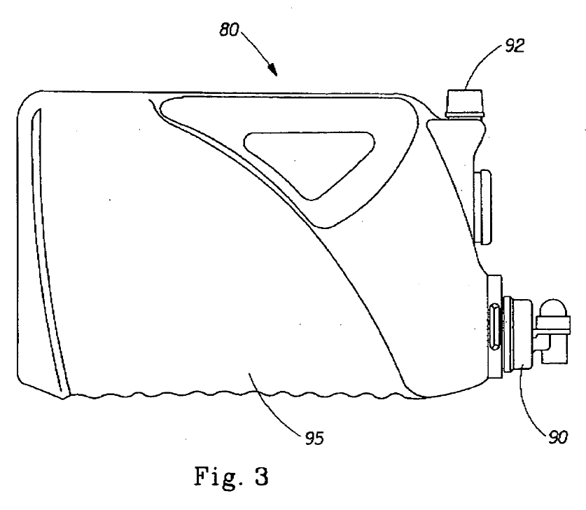

FIG. 3 illustrates another possible laundry product 80 that is similar to the laundry product 10 of FIG. 1. Laundry product 80 has a tap 90, a venting cap 92 and a body 95. The laundry product 80, like laundry product 10 of FIG. 1, is illustrative of laundry products that are readily available to consumers when they purchase in bulk.

The flowable composition in one specific embodiment is a laundry composition which is capable of being dispensed via a tap, such as powders, pastes, liquids, gels, liquid gels, thixotropic liquids/shear thinning liquids, granules, slurries, and the like and combinations thereof. In one optional embodiment, the laundry composition is selected from detergent compositions, for example, solid (but flowable) laundry detergents (i.e. granules, powders, pastes and the like); liquid laundry detergent or HDL (including gels, liquid-gels, thixotropes, shear thinning liquids, liquids, etc and the like); light duty detergents or LDD; bleaching compositions; fabric softening compositions; pretreater compositions; and fabric refreshing compositions and the like. Examples of some laundry compositions are described in U.S. Pat. Nos. 4,515,705; 4,537,706; 4,537,707; 4,550,862; 4,561,998; 4,597,898; 4,968,451; 5,565,145; 5,929,022; 6,294,514; and 6,376,445.

In another alternative embodiment the flowable composition is an ingredient composition, consists of one or more, more specifically from about 1 to about 5, ingredients that are typically present in a laundry composition, such as surfactants, enzymes, builders, and other adjunct ingredients such as, clarifiers, pearlescents, opalescents, enzyme inhibitors, brighteners, dye transfer inhibitors, dyes, bleach catalysts and/or bleach boosters, bleach activators, buffers, antimicrobial agents, UV absorbers, fabric softening additives, suds suppressors, dispersing agents, processing aids, structurants and mixtures thereof. Different ingredient compositions may be combined in varying amounts to form any number of customized laundry compositions. When the flowable composition comprises such a ingredient composition it is ideally suited for use in a laundry appliance that has a number of receivers, e.g. one receiver for the laundry product consists of surfactant or a mixture of surfactants, one receiver for the laundry product which consists of builder, one receiver for the laundry product which consists of enzyme, one receiver for the laundry product which consists of a mixture of adjunct ingredients, etc. These different laundry products can be dosed directly to, for example, a wash tub thereby forming a customized laundry composition in-situ. Alternatively, the different laundry products can be dosed to a separate chamber to form a customized laundry composition therein which is then delivered to the appropriate portion of the laundry appliance, such as, a wash tub/drum of a tumble dryer. Either situation allows for customization which can be controlled by the consumer, and/or the laundry appliance. Some illustrative factors that may be considered when preparing a customized laundry composition include, load size, fabric type, water hardness, water volume, soil type, soil level, water temperature, dryer temperature, dryer temperature, and the like and combinations thereof.

In another specific embodiment, the flowable composition is a carrier fluid. The carrier fluid may be any fluid suitable for use in a laundry appliance. The carrier fluid may be aqueous or nonaqueous fluids, such as, water; polysiloxanes; dry cleaning solvents; C₁-C₆ alkanols, such as, methanol, ethanol and/or propanol and/or 1-ethoxypentanol; C₂-C₆ diols; C₃-C₈ alkylene glycols; C₃-C₈ alkylene glycol mono lower alkyl ethers; glycol dialkyl ether; lower molecular weight polyethylene glycols; C₃-C₉ triols such as glycerol; and mixtures thereof. Additionally, the carrier fluid may also include adjuncts, such as, wetting agents, surfactants, enzymes, builders, clarifiers, pearlescents, opalescents, enzyme inhibitors, brighteners, dye transfer inhibitors, dyes, bleach catalysts and/or bleach boosters, bleach activators, buffers, antimicrobial agents, UV absorbers, fabric softening additives, suds suppressors, dispersing agents, processing aids, structurants and mixtures thereof. The carrier fluid may also be selected to have specific physical/chemical properties, such as, pH, hardness, dissolved oxygen content, conductivity, and the like and combinations thereof.

The carrier fluid can be delivered to the laundry appliance as a substitute and/or adjunct to the fluid that it normally uses in it laundry process. For example, if the laundry appliance was a washing machine the receiver could supply an aqueous carrier fluid of a specific pH and conductivity to be used as the wash water, to which a laundry detergent could be added, for example, via another receiver. Alternatively, the carrier fluid could be non aqueous, such as a polysiloxane, to allow for nonaqueous cleaning in a home laundry appliance. The delivery of a carrier fluid via the receiver to a laundry appliance, also allows for the appliance to be used in situation where it would be normally unusable, such as, when no potable water is available.

As used herein, “tap,” also know as “dispensing tap,” “press tap” or “spigots” refers to in the broadest sense a compact tap, more specifically plastic and/or polymeric, designed for easy operation for use in containers for flowable compositions, such as liquids, gels, pastes, and the like. Typically these comprise a valve assembly and an actuator for opening the valve to dispense the flowable composition. The actuator may be any suitable actuator, such as press button, lever, faucet like and the like. The valve is typically fluid tight, more specifically air tight. The taps are typically made of plastic, rubber or the like, but may contain other material, and typically have a relatively simple construction. Illustrative examples of some suitable dispensing tabs can be found in U.S. Pat. Nos. 4,452,425, 4,632,362, 4,471,807, 5,102,017, 5,337,775, 6,401,752, 6,435,382, 6,470,910, 6,631,744, and 6,896,158; and in U.S. Design Pat. Nos. D470,054, D474,112 and D478,504.

Illustrative examples of commercially available taps may be obtained from Worldwide Dispensers of Minnesota, USA.

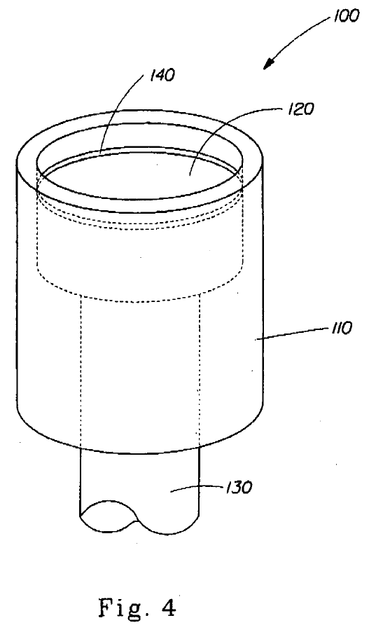

FIG. 4 is an illustrative example of one possible receiver 100, comprising a connector 110. The connector 110 may be made of any suitable material, but typically will comprise a material that is durable, wear resistant and compatible with, more specifically resistant or chemically stable in the presence of the flowable composition it comes in to contact with. In one more specific embodiment, the connector is selected from a polymeric material, a metallic material, a composite material and combinations thereof. In an even more specific embodiment, the polymeric material may be selected from polyacrylates, polyolefins, polycarboxylates, polyesters, polyethers, polyvinlychlorides, synthetic rubber, natural rubber, and combinations thereof. In another even more specific embodiment the metallic material is steel, titanium, stainless steel, aluminum, brass, copper, and the like, and combinations thereof.

The connector 110 comprises an inlet 120 and an outlet 130. The outlet 130 may be an integral part of the connector 110, or it may be a separate piece which may be permanently affixed to the connector 110, or removably attached to the connector 110.

The connector 110 may comprise one or more seating means 140. These seating means 140 may be in the form of a grove, ridge, lip or the like, for aiding in the retention of a tap in the connector 110. Alternatively, the optional seating means 140 may be a seal or the like to assist in providing a fluid tight, more specifically an airtight seal between the connector 110 and any tap placed therein. Illustrative examples of suitable seals include, O-rings, gaskets, washers, and the like and combinations thereof. In one optional embodiment, the connector 110 comprises two or more seating means, at least one of which is in the form of a grove, ridge, lip or the like, while at least one of the seating means is a seal or the like.

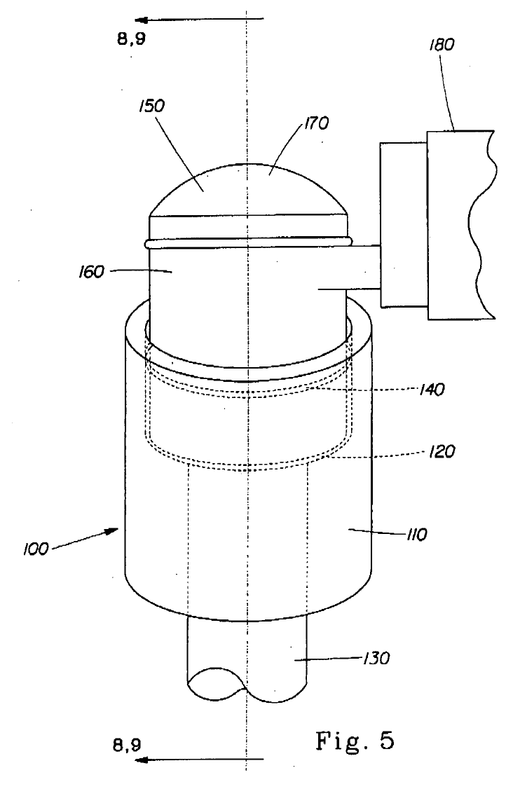

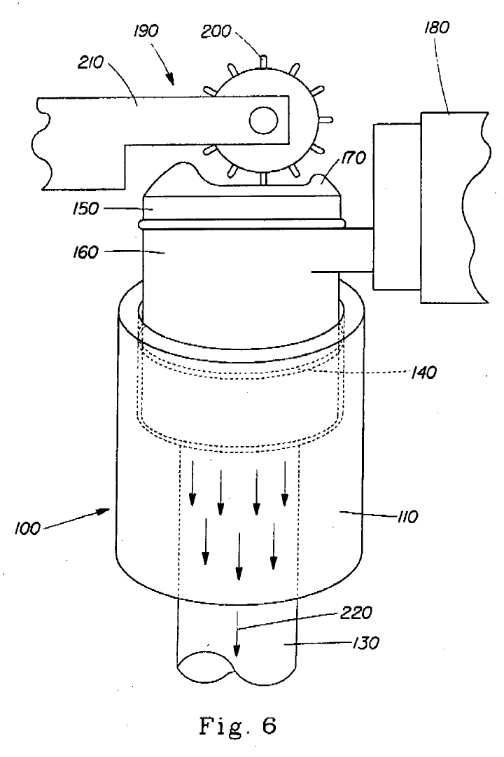

FIG. 5 is an exemplary illustration of the receiver 100 of FIG. 4, when a tap 150 placed therein and is in fluid communication with the connector 110. The tap 150 having a body 160 and a press tab 170 as an actuator. The flowable composition 220 (FIG. 6) is dispensed, by the dispensing means which is in association with the connector 120, from the laundry product 180 via the body 160 into the connector 120, through the outlet 130.

The receiver also comprises a dispensing means, which is in association with the connector. In one specific embodiment, the dispensing means may be selected from one or more of mechanical means, pressure means, or displacement means. In one specific embodiment the mechanical means may be an actuator, more specifically selected from a cam, a bearing, a wheel, a gear, rib, a nodule, a lug, a protuberance, a lip, a rim and the like and combinations thereof. The actuator may comprise any suitable material, such as, a material selected from plastic, metal, ceramic, and combinations thereof. FIG. 6 is one illustrative example of a receiver 110 having a dispensing means 190 which is a mechanical means, more specifically an actuator, namely a gear 200. In this illustrative embodiment once the tap 150 is releasably attached to the connector 120, the dispensing means 190 is then positioned such that it is in contact with and exerting sufficient force/pressure on the press tab 170 to allow flowable composition 220 to flow from the tap 150 via the body 160 into the connector 120, through the outlet 130.

While the dispensing means 190 exemplified in FIG. 6, is only capable of keeping the tap 150 in the open position, alternative dispensing means such as, a cam, could exert a variable force/pressure on the tap 150 thereby allowing for the tap 150 to be opened or closed as desired. In one specific embodiment the dispensing means is capable of opening and closing the tap 150 via exertion of variable force/pressure to the tap 150, more specifically this variable application of force/pressure may be performed by a controller that can vary the force/pressure exerted on the tap 150 by the actuator. This optional controller may be any suitable controller and may be mechanical, electromechanical, electric or combinations thereof. The optional controller may be part of the receiver and, optionally, be in communication with any laundry appliance to which the receiver is attached. Alternatively, the optional controller may be an integral part of a laundry appliance to which the receiver is attached to or is also an integral part of.

In one more specific embodiment the displacement means may be selected from fluid means, gas means and combinations thereof. Illustrative examples of fluid means include: the use of a high speed gas to force the tap to open, thereby dispensing the flowable composition, such as via application of Bernoulli's principle; or via the application of an inert gas, such as air, nitrogen, helium, and the like, into the laundry product, for example via the venting cap 30 of the laundry product 10 of FIG. 1, to force the flowable composition out of the tap 20.

In another more specific embodiment the pressure means is selected from pumping means, vacuum means, venturi means, and combinations thereof. In one more specific embodiment the pumping means, is selected from a peristaltic pump, a vacuum pump, displacement pump, positive displacement pump, gear pump, piston pump, hydraulic pump, centrifugal pump, and combinations thereof.

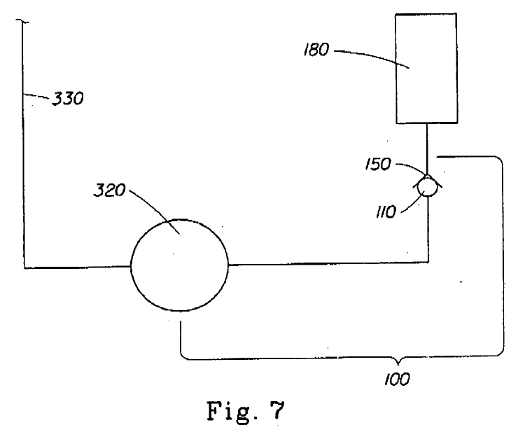

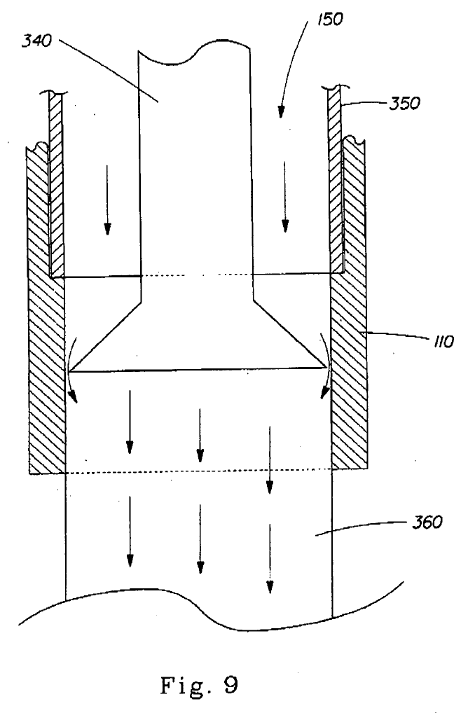

In FIGS. 4 and 5 the dispensing means is not illustrated, however if for example, the dispensing means were to be in fluid communication with the outlet 130, then a displacement means, pressure means or combination thereof may be suitable to dispense the flowable composition. FIG. 7 is an exemplary stylized representation of such a receiver comprising the receivers of FIGS. 4 and 5, where the dispensing means is a pumping means. In FIG. 7, the receiver 100 comprises a connector 110 and a dispensing means, namely a pumping means 320. The laundry product 180 comprises a tap 150 which is releasably attached to the receiver 100 via the connector 110. Flowable composition 360 (FIG. 9) is dispensed from the laundry product 180 via tap 150, and connector 110 to conduit 330, by the pumping means 320. The pumping means 320 exerts sufficient pressure/force to the tap 150 to open it all allow flowable composition 360 (FIG. 9) to flow in to connector 110. The pumping means 320 then delivers the flowable composition 360 (FIG. 9) along conduit 330 to its ultimate destination, typically a laundry appliance.

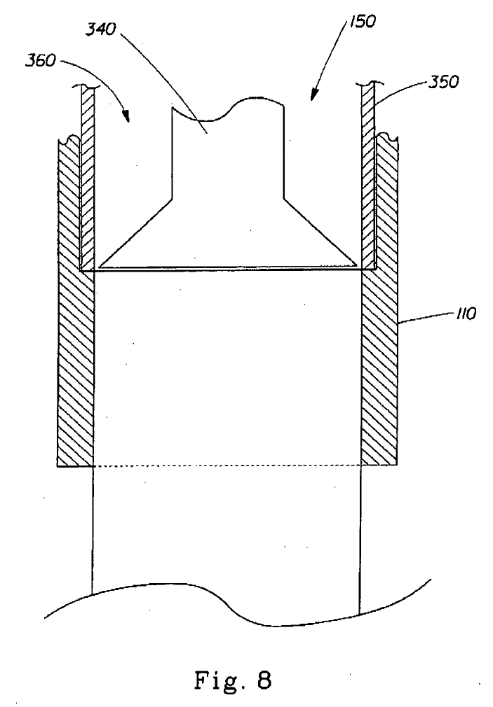

FIGS. 8 and 9 are provided to illustrate how a displacement means or a pressure means, such as a pumping means is able to deliver flowable composition 360 from the laundry product 180. FIG. 8 is a sectional view along line 5 of FIG. 5, and shows the tap 150 in the closed position. This sectional view shows the wall 350 and valve 340 of the tap 150 removably attached in to the connector 110. The valve 340 in the sealed or closed position, as illustrated in FIG. 8 prevents any of the flowable composition 360 from entering the connector 110. The tap 150 in the closed position also acts as a de-facto check valve, by preventing any material from entering the tap 150, and ultimately the laundry product 180 from the conduit 110.

FIG. 9 is an alternative sectional view along line 5 of FIG. 5 and shows the tap 150 in the open position. This sectional view shows the wall 350 and valve 340 of the tap 150 removably attached into the connector 110. The valve 340, as illustrated in the open position in FIG. 9, allows flowable composition 360 to enter the connector 110.

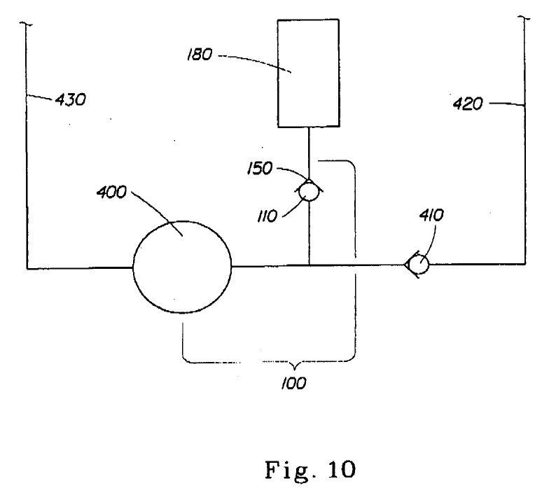

FIG. 10, like FIG. 7, is another exemplary stylized representation of a dispensing system comprising the a receive of the type illustrated in FIGS. 4 and 5, where the dispensing means is a pumping means, more specifically a peristaltic pump or the like. Suitable peristaltic pumps include bi-directional positive displacement pump capable of creating enough draw to overcome the cracking pressure of the tap 150, such as those commercially available from Thomas Pump & Machinery of Slidell, La. USA. In FIG. 10, the receiver 100 comprises a connector 110 and a dispensing means, namely a peristaltic pump 400. The laundry product 180 comprises a tap 150 which is releasably attached to the receiver 100 via the connector 110. In one specific embodiment the flowable composition 360 is dispensed from the laundry product 180 via tap 150, and connector 110 to conduit 430, by the peristaltic pump 400, while the check valve 410 is closed thereby preventing any flowable composition 360 from entering conduit 420 and form any of the material present in conduit 420 from mixing with the flowable composition 360. The peristaltic pump 400 exerts sufficient negative pressure/force to the tap 150 to open it and allow flowable composition 360 to flow in to connector 110, then along conduit 430 to its ultimate destination, typically a laundry appliance. After sufficient flowable composition 360 has been delivered to its ultimate destination the peristaltic pump 400 stops, thereby closing tap 150 and then optionally pumps in the opposite direction. In one more specific embodiment, the check valve 410 is then opened and peristaltic pump 400 then draws a fluid, such as, water from the wash basin of a washing machine, the washing machines water supply and/or directly from a domestic water supply, down conduit 430 passing into the connector 110 but past the tap 150 as it is in the closed position, and to a suitable repository for such fluid via the conduit 420. In one more specific embodiment the fluid is water from a laundry appliance, typically a washing machine, which is cycled through the receiver 100 and the attached conduits 420 and 430 to remove any remaining flowable composition 360. This diluted flowable composition 360 is then delivered to the wash basin of the washing machine via conduit 420 where it may be used in the appropriate cleaning/care cycle, e.g. laundry detergent would be used in the washing portion, whereas fabric softener would typically be used in the rinse cycle. This flushing or cleaning of the receiver 100 may act to prevent waste of flowable composition 360 as well as preventing build up of unused flowable composition 360 in, for example, connector 110, peristaltic pump 400, check valve, 410, conduits 420 and 430, and/or other parts of the receiver 100. This flushing or cleaning may also act as a preventative maintenance of the receiver and the parts connected thereto and will likely at least preserve, if not extend the useful life of the receiver 100. The flushing may be done once or may be repeated any number of times, use any volume, or for any desired length of time. This flushing also allows for the use of the same pumping means and/or conduits by different connectors that are attached to incompatible flowable compositions.

The embodiment illustrated in FIG. 10 is readily capable of being directly integrated into a laundry appliance as the peristaltic pump 400 could be, for example, made part of an integral part of the wash water delivery system of a washing machine and the pump used, for example, to deliver the wash and/or rinse water for a washing machine. While it is within the scope of the present invention to have a receiver that is an integrated part of a laundry appliance, it is also within the scope of the present invention to have a receiver that is separate and independent of any one laundry appliance. In the later embodiment the receiver would be capable of being used with a laundry appliance, without the need to alter or modify the laundry appliance, and/or its use in any fashion. In another specific embodiment the receiver would be capable of being used with a specific laundry appliance, such as connecting and/or affixing the receiver to the laundry appliance via a conduit, pipe, tube, or the like and combinations thereof. In this embodiment the receiver, may be permanently attached to the laundry appliance or it may be detachable and capable of being moved from one laundry appliance to another.

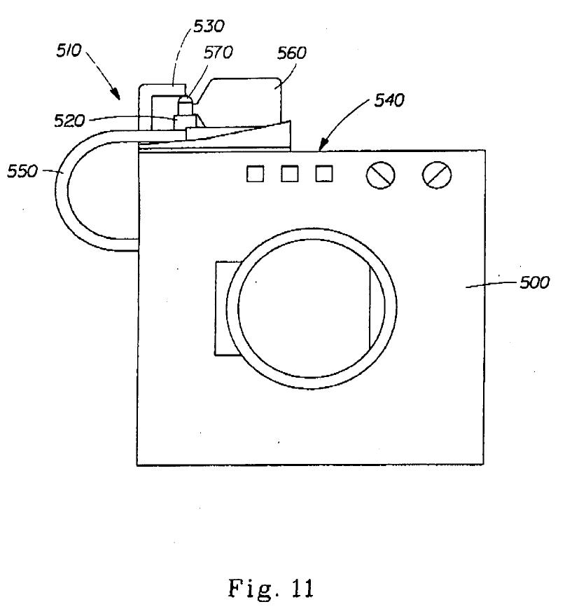

FIG. 11 shows a laundry appliance, in this case a front loading washing machine 500, with a receiver 510 placed on the top 540 of the front loading washing machine 500. These front loading washing machines 500, are also sometime known as European style washing machines. The receiver comprises a connector 520 and dispensing means, in this case an actuator 530. The laundry product 560, in this case laundry detergent, is releasably attached to the connector 520 via the tap 570. Attached to the connector 520 is conduit 550 which is attached to the washing machine 500 and supplies the detergent composition to the washing machine from the laundry product 560 as needed. In one specific embodiment the actuator 530 maintains the tap 570 in the open position once the laundry product 560 is releasably attached to the connector 520. The supply of detergent composition to the washing machine is then controlled by any suitable means, such as a check valve, or pump, which is controlled via the washing machine 500.

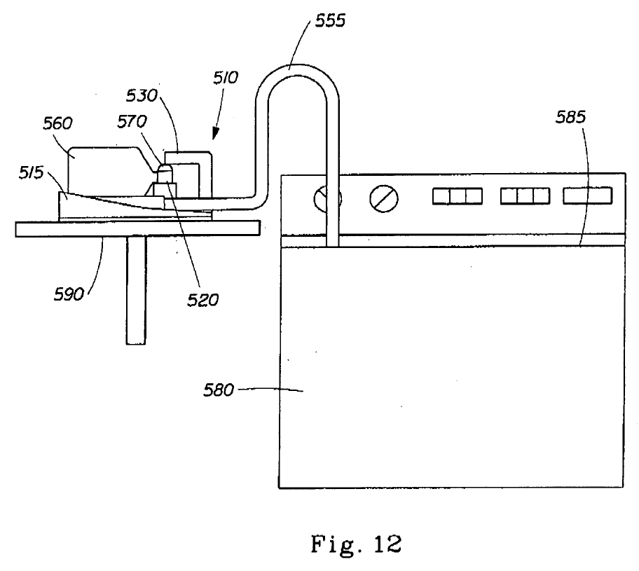

FIG. 12 shows another laundry appliance, in this case a top loading washing machine 580, with a receiver 510 placed on a shelf 590 which is adjacent to the washing machine 580. The receiver 510 also includes a track 515. The track 515 may be inclined at a slight angle to the horizontal, more typically from about 1 degree to about 45 degrees, even more specifically from about 5 degrees to 40 degrees, even more specifically still from about 10 degrees to about 35 degrees.

The receiver 510 may be able to have its height varied with in a given range by any suitable means, or it may be a fixed height. The varying in height could be done manually, automatically or a combination thereof.

Alternatively, the track 515 and the laundry product 560 thereon may be initially horizontal, and as flowable composition is dispensed, the angle of the track 515 may be changed over time to assist in the complete dispensing of the flowable composition from the laundry product 560. This change may occur during dispensing and/or after. In one specific embodiment this change over time is done by a spring or the like. In this optional embodiment the track 515 has associated therewith one or more springs, or similar mechanism, that when a “full” laundry product 560 is placed on the track 515, it is horizontal because of the weight of the flowable composition in the laundry product 560. As the flowable composition is dispensed, the weight of the laundry product 560 decreases, thereby lessening the force on the spring, which then lifts the track 515, such that the laundry product 560 is now at some angle to the horizontal. This arrangement has the added advantage of providing to the consumer a visual signal as to approximately how much flowable composition remains, or at least when the laundry product 560 is empty of flowable composition. Other illustrative ways of tilting the track 515 and/or the laundry product 560 directly, include, levers, pistons, pulleys and the like and combinations thereof.

Additionally, variable angle or tilting arrangement may be linked in to one or more devices for determining the amount or volume of flowable composition remaining in the laundry product 560. The information on how much flowable composition remaining is then used to determine the optimum dispensing angle for the track 515. This optimum dispensing angle will also depend upon many factors, for example, the shape and/or size of the laundry product 560, the viscosity of the flowable composition and the like.

Additionally, the track 515 may be used to stabilize the laundry product 560 and to assist in the maintenance of the tap 570 in the connector 520. In one optional embodiment, not illustrated, the track 515 may be movable and have at least two positions. Namely, a first or loading position where the laundry detergent 560 is placed on the track 515 and a second or engagement position where the tap 570 is releasably attached to the connector 520.

FIG. 12 also illustrates an example of where the conduit, in this case conduit 555 is not directly attached to a washing appliance. The conduit 555 is located close to the opening or door 585 of the top loading washing machine 580 only when the detergent composition is required, such as during the loading of the top loading washing machine 580 or for pre treating fabric with the flowable composition. This arrangement means that the receiver along with the laundry detergent 560 and conduit 555 can be moved and used with any washing machine.

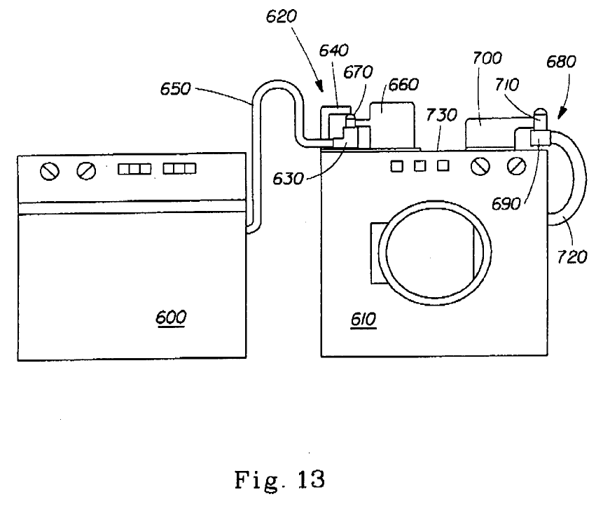

FIG. 13 illustrates a pair of laundry appliances, namely a top loading washing machine, 600, and a tumble dryer 610. Placed on the top of the tumble dryer 610 are two different receivers 620 and 680. Receiver 620 comprises a connector 630 and dispensing means, in this case an actuator 640. The laundry product 660 in this case laundry detergent is releasably attached to the connector 630 via the tap 670. Attached to the connector 630 is conduit 650 which is attached to the washing machine 600 and supplies the detergent composition to the washing machine from the laundry product 660 as needed. In one specific embodiment the actuator 640 maintains the tap 670 in the open position once the laundry product 660 is releasably attached to the connector 630. The supply of detergent composition to the washing machine is then controlled by any suitable means, such as a check valve, or pump, which is controlled via the washing machine 600.

Receiver 680 comprises a connector 690. The laundry product 700, in this case fabric care product is releasably attached to the connector 690 via the tap 710. Attached to the connector 690 is conduit 650 which is attached to the tumble dryer 610, via the dispensing mean and supplies fabric softener composition to the washing machine from the laundry product 700 as needed. The dispensing means, in this case either a displacement means or a pressure means is located inside a portion tumble dryer 610, which is attached to the connector 690 via conduit 720, and is not shown. The supply of fabric softener composition to the tumble dryer 610 is then controlled by any suitable means, such as a check valve, or pump, which is controlled via the tumble dryer 600.

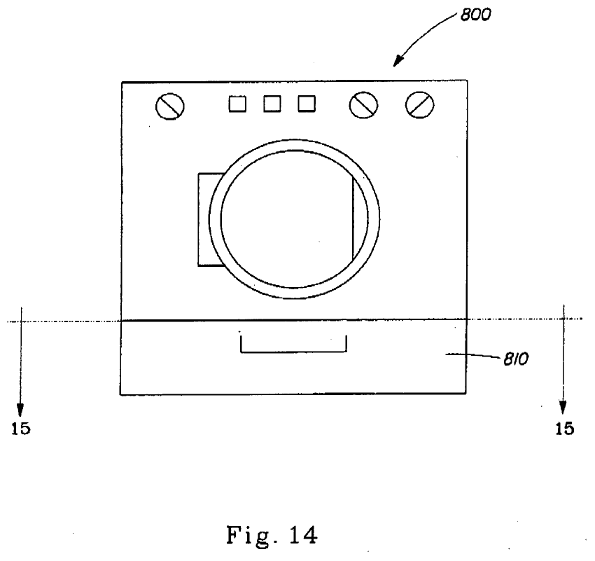

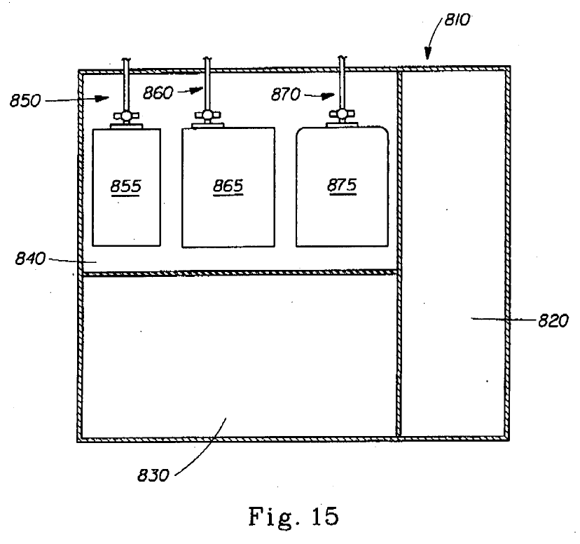

FIG. 14 is an illustrative example of a front loading washing machine 800 that includes a drawer 810. (These drawers 810 are also know as pedestals or pedestal drawers). Typically, the drawer 810 provide at least two desirable features, firstly they elevate the height of the front loading washing machine 800 so a consumer does not have to bend over, or even bend at all while they are loading or unloading fabrics from the front loading washing machine 800. Secondly, to enable consumers to use the drawer 810 as a storage compartment for various laundry products, devices and the like. These drawers may contain any number of compartments of any size or arrangement, or even be a single undivided compartment. FIG. 15 illustrates along section line 8 a top view of one possible drawer 810. The drawer 810 contains three compartments 820, 830 and 840. Compartments 820 and 830 are typically used for storage, for example of: additional unopened laundry product; related laundry product, such as, dryer sheets, dye trapping sheets, pretreating compositions, and the like; related laundry devices and apparatus, such as, ultrasonic pretreating devices, clothes hangers, pegs, trash bags and the like; and combinations thereof.

Compartment 840 contains three different receivers 850, 860 and 870 to which are removably attached three different laundry products 855, 865 and 875 respectively. In one specific embodiment the laundry product 855 is a bleaching product, laundry product 865 is a fabric care product and laundry product 875 is a laundry detergent. In an alternative embodiment, the laundry product 855 consists of a surfactant, typically an anionic surfactant, more typically an anionic surfactant, nonionic surfactant, cationic surfactant, amphoteric surfactant zwitterionc surfactants and mixtures thereof, the laundry product 865 consists of an enzyme, and the laundry product 875 consists of adjuncts comprising a mixture of a builders, brighteners, dye transfer inhibitors, perfume, and suds suppressors. Additionally, in another alternative embodiment laundry product 855 is an aqueous carrier fluid, laundry product 865 is a nonaqueous carrier fluid, and laundry product 875 is a liquid laundry detergent.

In one optional embodiment, the receiver may have in association therewith a controller. This optional controller may be an integral part of the receiver, be an integral part of a laundry appliance to which the receiver is connected to or combinations thereof. The controller may be mechanical, electromechanical, electronic or combinations thereof. The controller may be part or be the controller which operates the laundry appliance to which the receiver is attached or an integral part of.

In one optional embodiment, the receiver may additionally have in association therewith a device for delivering measured volumes of the flowable composition via the receiver. This may be done in any suitable manner, for example, by measuring the volume of flowable composition dispensed through the connector, measuring the volume of flowable composition dispensed through the dispensing means, and the like.

In another optional embodiment, the receiver may additionally have in association therewith a device for determining the amount or volume of flowable composition remaining in the laundry product. This may be done in any suitable fashion, such as via a scale or the like positioned under the laundry product to determine when the laundry product is empty or nearly empty; or via determinations of the total volume of product of dispensed from the laundry product. This information may then be directly supplied to the consumer to alert them that the laundry product will need to be replaced soon, or to even prevent the laundry appliance from operating as in sufficient flowable composition remains for its appropriate use.

In one optional embodiment, the receiver has in association therewith an input device where information about the laundry product can be entered into any controller of the receiver. This information may include, for example, product size or volume, product brand, product weight, product type, and the like and combinations thereof. The optional input device may be any device which is capable of receiving input, more typically in some manner which is consumer acceptable and relatively easy to use. Illustrative examples, includes, bar code reader, radio frequency identification reader, keyboard, scales, flow meter, dials, buttons, touch screen, touch pad, volume measuring devices, and the like and combinations thereof. In one specific optional embodiment the input device is a bar code reader, which can scan the laundry product before, during and/or after it is removably attached to the receiver. Additional information on some suitable input devices may be found in U.S. Patent Publication No. 2001/0049846.

In one optional embodiment, a laundry appliance with a receiver integrally mounted therein is provided. In one more specific embodiment, the receiver is inside the housing of a laundry appliance and may only be accessed through an opening in the panel. This opening may be covered, or it may be exposed. Optionally, the opening is covered with a cover. In this embodiment there is a cavity or space in the laundry appliance where the laundry product resides when it is removably attached to the connector. This cavity or space may of any suitable size or shape such that it can accommodate any sized laundry product which has a tap. Alternatively, the cavity or space may be of a size or shape so that is can only accommodate one brand of laundry product, one size of laundry product and/or laundry product from one supplier/source/manufacturer.

In another optional embodiment, the receiver may comprise additional means to assist or aid in the retention of the tap in the connector of the receiver. Illustrative examples of this includes, catches, hooks, straps, notches, holders, grips, clamps, ties, and the like that may be connected and/or attached to the tap and/or the laundry product to assist in the retention of the tap in the connector.

In another specific embodiment the receiver and components thereof are capable of releasably attaching to accommodate a range of shapes and sizes of laundry products. In another specific embodiment one or more parts of the receiver are capable of having their position and/or orientation altered relative to one or more parts of the receiver, such as the receiver can be moved relative to the dispensing means. This altering of relative position may be done in order to, for example, enable the receiver to accommodate different sized laundry products, to facilitate easy removal and/or placement of a laundry product in the connector, etc.

The connector may be of any suitable size and/or shape provided it is adapted for releasably attaching the receiver to the laundry product.

In one specific embodiment the connector comprises a first end and a second end, the first end is adapted for releasably attaching the receiver to the tap and the first end, when attached to the tap, is in fluid communication with the second end, more specifically the second end is adapted for attaching the receiver to a laundry appliance, for example via a delivery tube attached to and in fluid communication with the second end, when attached to the tap.

In one optional embodiment, when the receiver is integrally mounted in the laundry appliance, the laundry product may be removably attached to the connector via means of a loading device. One illustrative possible loading device would be a device similar to a those used in loading a cassette tape or a compact disk. In these types of loader there are typically two positions, one where the laundry product is placed on the tray, and a second where the laundry product is removably attached to the connector. This change in position may be done through the consumer physically pushing the laundry product from the first position to the second position, like what happens when loading a cassette tape, or the loading is done automatically, such as when loading a compact disk.

In one more specific embodiment, the receiver may comprise:
(a) a housing comprising a proximal end and a distal end;
(b) a support member perpendicularly attached to the proximal end of the housing, the support member comprising a freely rotatable toothed gear affixed to the support member;
(c) an engagement chassis permanently attached to the housing, the engagement chassis detachably retaining a laundry product having a tap, such that the toothed gear continuously engages the press tab of the tap of the laundry product;
(d) a connector in association with the proximal end of the housing, the support member and the engagement chassis, the connector comprises a first end and a second end, wherein the first end detachably engages and is in fluid communication when engaged with the outlet of the tap of the flowable composition; and
(e) a dispensing tube for delivering the dispensed flowable composition to a laundry appliance, the dispensing tube comprising a proximal end and a distal end, wherein the proximal end of the dispensing tube engages and is in fluid communication with the second end of the connector, and the distal end of the dispensing tube engages and is in fluid communication with the laundry appliance.

In one more specific embodiment, a method for reduced or no mess delivery a flowable composition to a laundry appliance is provided. The method comprises the step of attaching a laundry product having a tap to any of the receivers described herein.

In another more specific embodiment, a laundry appliance is provided wherein the laundry appliance has one or more of the receivers described herein attached thereto, more specifically the appliance comprises a drawer and said receiver is in association with said drawer.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

Except as otherwise noted, the articles “a,” “an,” and “the” mean “one or more.”

Markush language as used herein encompasses combinations of the individual Markush group members, unless otherwise indicated.

All numerical ranges disclosed herein, are meant to encompass each individual number within the range and to encompass any combination of the disclosed upper and lower limits of the ranges.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A receiver for a laundry product, wherein the laundry product has a tap, said receiver comprising:
(a) a connector adapted for releasably attaching said receiver to said tap, wherein said connector, when attached to said tap, is in fluid communication with said tap; and
(b) a dispensing means in association with said connector.

2. The receiver according to claim 1 wherein said dispensing means is selected from one or more of mechanical means, pressure means, and displacement means.

3. The receiver according to claim 2 wherein said mechanical means is an actuator.

4. The receiver according to claim 2 wherein said displacement means is selected from one or more of fluid means, and gas means.

5. The receiver according to claim 2 wherein said pressure means is selected from one or more of pumping means, vacuum means and venturi means.

6. The receiver according to claim 2 wherein said pumping means is selected from one or more of a peristaltic pump, a vacuum pump, a displacement pump and a centrifugal pump.

7. The receiver according to claim 1 wherein said connector further comprises a first end adapted for releasably attaching said receiver to said tap and a second end adapted for attaching said receiver to a laundry appliance, wherein said first end, when attached to said tap, is in fluid communication with said second end.

8. The receiver according to claim 7 wherein said first end comprises a sealing means adapted for releasably attaching said receiver to said tap, and said sealing means is selected from O-ring, seal, grove, notch, washer, and combinations thereof.

9. The receiver according to claim 1 wherein said laundry product when attached to said connector is capable of being inclined at an angle of from about 1 to about 45 degrees.

10. The receiver according to claim 6 further comprising a controller capable of controlling the variable force/pressure exerted by said pumping means.

11. A method for delivery of a flowable composition to a laundry appliance comprising the step of attaching a laundry product having a tap to a receiver according to claim 1.

12. A laundry appliance having a receiver according to claim 1 attached thereto.

13. The laundry appliance according to claim 12 wherein said appliance comprises a drawer and said receiver is in association with said drawer.

14. The receiver according to claim 1 wherein said laundry product is selected from one or more of laundry detergents, fabric softeners, bleaching compositions, or fabric treatment compositions.

15. A laundry appliance comprising:
(1) at least one receiver for a laundry product, wherein the laundry product has a tap, said receiver comprising:
(a) a connector adapted for releasably attaching the receiver to the tap, wherein the connector, when attached to said tap, is in fluid communication with the tap; and
(b) a dispensing means in association with said connector;

16. The receiver according to claim 15 wherein said connector further comprises a first end adapted for releasably attaching said receiver to said tap and a second end adapted for attaching said receiver to a laundry appliance, wherein said first end, when attached to said tap, is in fluid communication with said second end.

17. The laundry appliance according to claim 16 further comprising a delivery tube attached to and in fluid communication with said second end.

18. The laundry appliance according to claim 17 said laundry appliance is a washing machine comprising a wash tub and said dispensing means is a pumping means in fluid communication with said connector via said delivery tube, and said dispensing means is in fluid communication with said wash tub when attached thereto.

19. The laundry appliance according to claim 18 wherein said delivery tube comprises a proximal end, a distal end and a valve located between said proximal end and said a distal end, wherein said second end is attached to said delivery tube between said proximal end and said valve, and said pumping means is in association with said delivery tube between said proximal end and a place said second end is attached to said delivery tube.

20. The laundry appliance according to claim 19 wherein said pumping means is a peristaltic pump and said valve is a check valve.
